(19) United States
(12) Patent Application Publication
(10) Pub. No.: US 2005/0162351 A1
(43) Pub. Date: Jul. 28, 2005

(54) Method of driving a plasma display panel

(76) Inventor: So Nic Kim, Yeonsu-gu (KR)

Correspondence Address: MCKENNA LONG & ALDRIDGE LLP, 1900 K STREET, NW, WASHINGTON, DC, 20006, US

(21) Appl. No.: 10/983,094

(22) Filed: Nov. 8, 2004

(30) Foreign Application Priority Data
Nov. 8, 2003 (KR) 10-2003-0078850

(51) Int. Cl. G09G 3/28

(52) U.S. Cl. 345/63

(57) ABSTRACT

The present invention relates to a plasma display panel, and more particularly, to a method of driving a plasma display panel. According to an embodiment of the present invention, the method of driving the plasma display panel driven includes the steps of alternately applying a first sustain pulse to scan electrode lines and sustain electrode lines in a sustain period, applying a second sustain pulse having a pulse width wider than that of a first sustain pulse as a last sustain pulse in the sustain period, and before the second sustain pulse is applied, applying a wall charge enhanced pulse to one of the scan electrode lines and the sustain electrode lines. Accordingly, according to the present invention, a strong sustain discharge is generated by the last sustain pulse. Thus, sufficient wall charges necessary for a next erase address period can be formed and an erroneous discharge can be thus prevented.

This Nonprovisional application claims priority under 35 U.S.C. § 119(a) on Patent Application No. 10-2003-0078850 filed in Korea on Nov. 8, 2003, the entire contents of which are hereby incorporated by reference.

### BACKGROUND OF THE INVENTION

1. Field of the Invention

The present invention relates to a plasma display panel, and more particularly, to a method of driving a plasma display panel.

2. Description of the Background Art

A plasma display panel (hereinafter, referred to as a ‘PDP’) is adapted to display an image including characters or graphics by light-emitting phosphors with ultraviolet of 147 nm generated during the discharge of a gas such as He+Xe, Ne+Xe or He+Ne+Xe. This PDP can be easily made thin and large, and it can provide greatly increased image quality with the recent development of the relevant technology. Particularly, a three-electrode AC surface discharge type PDP has advantages of lower driving voltage and longer product lifespan as a voltage necessary for discharging is lowered by wall charges accumulated on a surface upon discharging and electrodes are protected from sputtering caused by discharging.

FIG. 1 is a perspective view illustrating the construction of a discharge cell of a three-electrode AC surface discharge type PDP in the prior art.

Referring to FIG. 1, the discharge cell of the three-electrode AC surface discharge type PDP includes scan electrodes 30Y and sustain electrodes 30Z which are formed on the bottom surface of an upper substrate 10, and address electrodes 20X formed on a lower substrate 18.

The scan electrode 30Y includes a transparent electrode 12Y, and a metal bus electrode 13Y which has a line width smaller than that of the transparent electrode 12Y and is disposed at one edge side of the transparent electrode. The sustain electrode 30Z includes a transparent electrode 12Z, and a metal bus electrode 13Z which has a line width smaller than that of the transparent electrode 12Z and is disposed at one side edge of the transparent electrode. The transparent electrodes 12Y, 12Z, which are typically made of ITO (indium tin oxide), are formed on the bottom surface of the upper substrate 10. The metal bus electrodes 13Y, 13Z, which are typically made of chrome (Cr), are formed on the transparent electrodes 12Y, 12Z, and serve to reduce a voltage drop caused by the transparent electrodes 12Y, 12Z having high resistance. On the bottom surface of the upper substrate 10 in which the scan electrodes 30Y and the sustain electrodes 30Z are placed in parallel with each other are laminated an upper dielectric layer 14 and a protective layer 16. On the upper dielectric layer 14 are accumulated wall charges generated during plasma discharge. The protective layer 16 serves to protect the upper dielectric layer 14 from sputtering generated during the plasma discharge, and improve efficiency of secondary electron emission. Magnesium oxide (MgO) is typically used as the protective layer 16.

The address electrodes 20X are formed in the direction in which they intersect the scan electrodes 30Y and the sustain electrodes 30Z. A lower dielectric layer 22 and barrier ribs 24 are formed on the lower substrate 18 in which the lower dielectric layer 22 is formed. The barrier ribs 24 are formed in parallel with the address electrodes 20X to physically divide the discharge cells, thus preventing ultraviolet and a visible ray generated by the discharge from leaking toward neighboring discharge cells. The phosphor layer 26 is excited with an ultraviolet generated during the plasma discharging to generate a visible light of any one of red, green and blue lights. An inert mixed gas such as He+Xe, Ne+Xe or He+Ne+Xe is injected into the discharge spaces of the discharge cells defined between the upper substrate 10 and the barrier ribs 24 and between the lower substrate 18 and the barrier ribs 24.

This three-electrode AC surface discharge type PDP is driven with one frame being divided into several sub-fields having a different number of emission in order to implement the gray scale of an image. Each of the sub fields is divided into a reset period for uniformly generating discharging, an address period for selecting a discharge cell, and a sustain period for implementing the gray level according to the number of discharging. If it is desired to display an image with 256 gray scales, a frame period (16.67 ms) corresponding to 1/60 seconds is divided into eight sub-fields SF1 to SF8, as shown in FIG. 2. Each of the sub-fields SF1 to SF8 is subdivided into a reset period, an address period and a sustain period. The reset period and the address period of each of the sub-fields SF1 to SF8 are identical to each other every sub-field, whereas the sustain period and the frequency of its discharging number increase in the ratio of 2ⁿ (where, n=0,1,2,3,4,5,6,7) in each sub-field. As the sustain period becomes different in each sub-field as such, the gray scale of an image can be implemented.

The driving method of this PDP can be mainly classified into a selective writing mode and a selective erasing mode depending on whether a discharge cell selected by an address discharge is light-emitted.

Of them, in the selective erasing mode, after the entire screen is turned on by performing a write discharge, the discharge cells selected in the address period are turned off. Thereafter, in the sustain period, only discharge cells which are not selected by the address discharge undergo a sustain discharge thereby displaying an image.

Practically, in the selective erasing mode, the entire screen undergoes the entire writing once every frame and unnecessary discharge cells are sequentially turned off every sub-fields SF1 to SF10, as shown in FIG. 3. In other words, the first sub-field SF1 includes a reset period, the entire writing period, an erase address period and a sustain period. The remaining sub-fields SF2 to SF10 include only the erase address period and the sustain period. As such, if the entire write discharge is generated once within one frame, unnecessary light generated in the one frame (i.e., light generated by the entire write discharge) is minimized, thus improving contrast.

In this time, in the selective erasing mode, a sustain pulse as shown in FIG. 4 is applied during the sustain period of the sub-fields SF1 to SF9 so that a stabilized erase address discharge is generated in the remaining sub-fields SF2 to SF10 which do not include the entire writing period.

Referring to FIG. 4, a start sustain pulse WISUS is applied to the scan electrode lines Y (or the sustain electrode lines Z). In this time, as the start sustain pulse WISUS has a pulse width wider than that of a normal sustain pulse NSUS, the amount of wall charges within on-cells are more increased than those when the normal sustain pulse NSUS is applied at the initial stage of the sustain period. The sustain discharge is thus stabilized. After the start sustain pulse WISUS is applied, the normal sustain pulse NSUS is alternately applied to the sustain electrode lines Z and the scan electrode lines Y.

In this time, since the last normal sustain pulse NSUS is applied to the sustain electrode lines Z, wall charges are formed in the discharge cell, as shown in FIG. 5a. In other words, the wall charges of the negative (−) polarity are formed in the scan electrode lines Y and the wall charges of the positive (+) polarity are formed in the sustain electrode lines Z.

Thereafter, a last sustain pulse WFSUS whose pulse width is set to be wider than that of the normal sustain pulse NSUS is applied to the scan electrode lines Y. In this time, as the pulse width of the last sustain pulse WFSUS is set to be wide, a strong sustain discharge is generated. Accordingly, as shown in FIG. 5b, more many wall charges are formed in the discharge cell whenever the normal sustain discharge is generated. In other words, more many wall charges of the negative (−) polarity than when the normal sustain discharge is generated are formed in the scan electrode lines Y. More many wall charges of the positive (+) polarity than when the normal sustain discharge is generated are formed in the sustain electrode lines Z. The wall charges generated by the last sustain pulse WFSUS are employed in an erase discharge of a next address period.

However, in the prior art, sufficient wall charges necessary for an erase discharge of a next address period are not formed by the last sustain pulse WFSUS. This will be below described in more detail.

Before the last sustain pulse WFSUS is applied, a small amount of wall charges is formed in the discharge cells by the normal sustain pulse NSUS, as shown in FIG. 5a. Since the last sustain pulse WFSUS is applied with the small amount of the wall charges being formed in the discharge cells, the amount of the wall charges that can be formed by the last sustain pulse WFSUS is limited. Accordingly, sufficient wall charges necessary for an erase discharge of a next address period are not formed. As such, in the conventional selective erasing mode, desired wall charges are not formed during the erase address period. Thus, there is a problem in that an erroneous discharge is generated in the sustain period. More particularly, such an erroneous discharge become more significant when the panel is driven at low temperature ranging from —50° C. to 0° C. That is, as movement of particles becomes blunt in a low temperature environment, desired wall charges are not formed by the last sustain pulse WFSUS and the erroneous discharge problem becomes thus more significant.

Meanwhile, in the selective writing mode, the entire cells are turned off during the reset period, and on-cells to be turned on are selected during the address period. Further, in this mode, during the sustain period, discharging of the on-cells selected by the address discharge is maintained thereby displaying an image.

Generally, the selective writing mode has an advantage in that a range of the gray scale that can be represented is wider than that of the selective erasing mode, but has a disadvantage in that the address period is longer than that of the selective erasing mode. On the contrary, the selective erasing mode as shown in FIG. 3 is advantageous in high-speed driving, but is disadvantageous in the limit of the gray scale that can be represented.

A so-called ‘SWSE (Selective Writing and Selective Erasing) mode’, which has advantages better than those of the selective writing mode and the selective erasing mode, has been disclosed in the related technology.

However, even this SWSE mode may have a problem in that desired discharge cells cannot be selected during the erase address period if the panel is driven in the selective erasing mode, especially, at low temperature.

### SUMMARY OF THE INVENTION

Accordingly, an object of the present invention is to solve at least the problems and disadvantages of the background art.

An object of the present invention is to provide a method of driving a PDP in which an erroneous discharge is prevented.

To achieve the above object, according to a first embodiment of the present invention, there is provided a method of driving a PDP driven in a selective erasing mode, including the steps of alternately applying a first sustain pulse to scan electrode lines and sustain electrode lines in a sustain period, applying a second sustain pulse having a pulse width wider than that of a first sustain pulse as a last sustain pulse in the sustain period, and before the second sustain pulse is applied, applying a wall charge enhanced pulse to one of the scan electrode lines and the sustain electrode lines.

According to a second embodiment of the present invention, there is provided a method of driving a plasma display panel in which one frame includes a plurality of selective writing sub-fields and a plurality of selective erasing sub-fields, including the steps of alternately applying a first sustain pulse to the scan electrode lines and the sustain electrode lines during a sustain period of one or more selective writing sub-fields and one or more selective erasing sub-fields, applying a second sustain pulse having a pulse width wider than that of a first sustain pulse as a last sustain pulse in the sustain period, and before the second sustain pulse is applied, applying a wall charge enhanced pulse to one of the scan electrode lines and the sustain electrode lines.

As described above, according to the present invention, a strong sustain discharge is generated by the last sustain pulse. Therefore, sufficient wall charges necessary for a next erase address period can be formed and an erroneous discharge can be thus prevented.

### BRIEF DESCRIPTION OF THE DRAWINGS

The invention will be described in detail with reference to the following drawings in which like numerals refer to like elements.

FIG.1 is a perspective view illustrating the configuration of a discharge cell of a three-electrode AC surface discharge type PDP in the prior art.

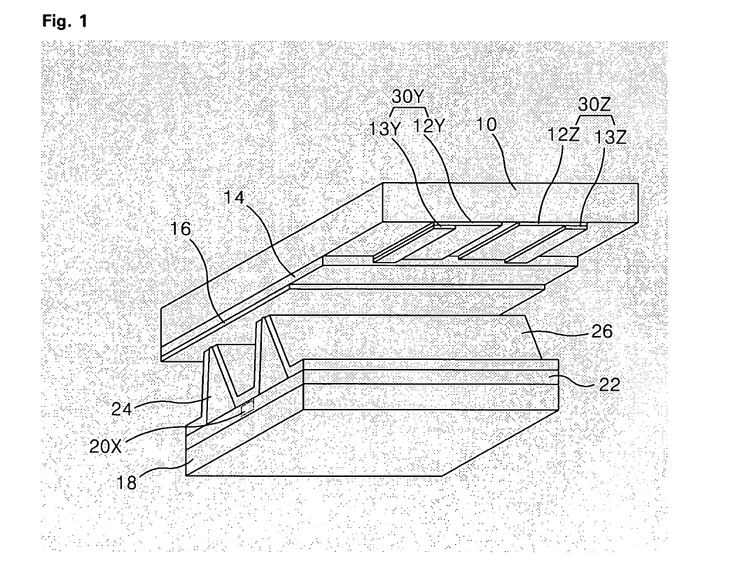

FIG. 2 illustrates an example of brightness weight of the PDP in the prior art.

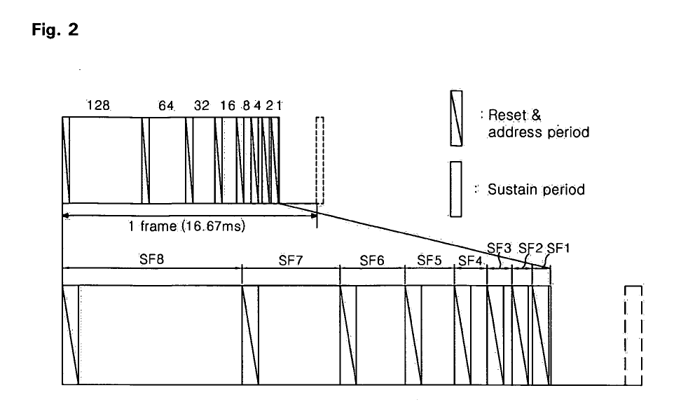

FIG. 3 sows one frame of a selective erasing mode in the prior art.

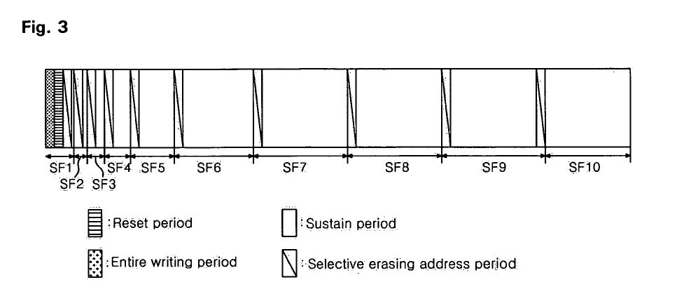

FIG. 4 shows a driving waveform applied to the sustain period shown in FIG. 3.

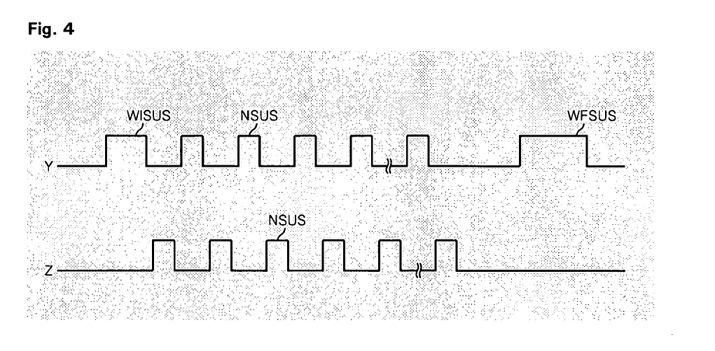

FIGS. 5a and 5b show wall charges formed in the sustain period.

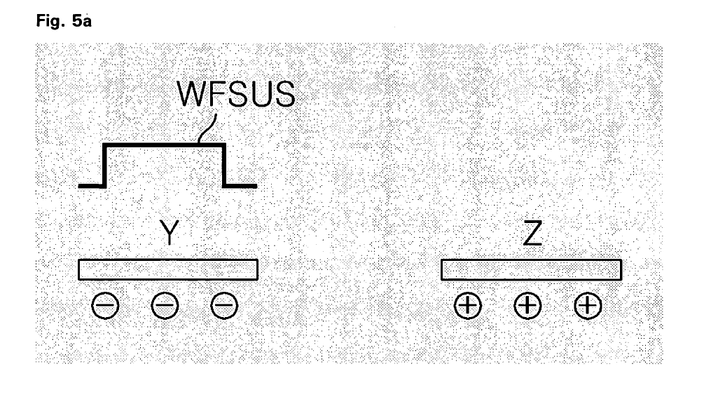

FIG. 6 shows a driving waveform supplied in the period of a selective erasing sub-field, for explaining a method of driving a PDP according to a first embodiment of the present invention.

FIGS. 7a to 7c show wall charges formed in the sustain period shown in FIG. 6.

FIG. 8 shows a state where selective erasing sub-fields and selective writing sub-fields are arranged within one frame when the PDP of the present invention is driven.

FIG. 9 shows a driving waveform supplied in the periods of a selective erasing sub-field and a selective writing sub-field, for explaining a method of driving a PDP according to a second embodiment of the present invention.

### DETAILED DESCRIPTION OF PREFERRED EMBODIMENTS

Preferred embodiments of the present invention will be described in a more detailed manner with reference to the drawings.

### First Embodiment

According to a first embodiment of the present invention, there is provided a method of driving a PDP driven in a selective erasing mode, including the steps of alternately applying a first sustain pulse to scan electrode lines and sustain electrode lines in a sustain period, applying a second sustain pulse having a pulse width wider than that of a first sustain pulse as a last sustain pulse in the sustain period, and before the second sustain pulse is applied, applying a wall charge enhanced pulse to one of the scan electrode lines and the sustain electrode lines.

The method further includes the step of, when the wall charge enhanced pulse is applied, applying a synchronization pulse to the other of the scan electrode lines and the sustain electrode lines to which the wall charge enhanced pulse is not applied so that the synchronization pulse is synchronized with the wall charge enhanced pulse.

The synchronization pulse is a square wave.

The synchronization pulse is set to have the same voltage value as the first sustain pulse.

The wall charge enhanced pulse has a voltage of negative polarity.

The wall charge enhanced pulse is a ramp wave that falls with a tilt.

The wall charge enhanced pulse falls to a voltage ranging from −80V to −60V.

The wall charge enhanced pulse falls to a voltage ranging from −72V to −68V.

The application time of the wall charge enhanced pulse is set to be within a range between 2 μs and 3 μs.

The wall charge enhanced pulse is applied in the sustain period of all the sub-fields included in one frame.

The wall charge enhanced pulse is applied in the sustain period of the remaining sub-fields except for the last one among a plurality of sub-fields included in one frame.

The wall charge enhanced pulse is applied only when the panel is driven in a low temperature environment.

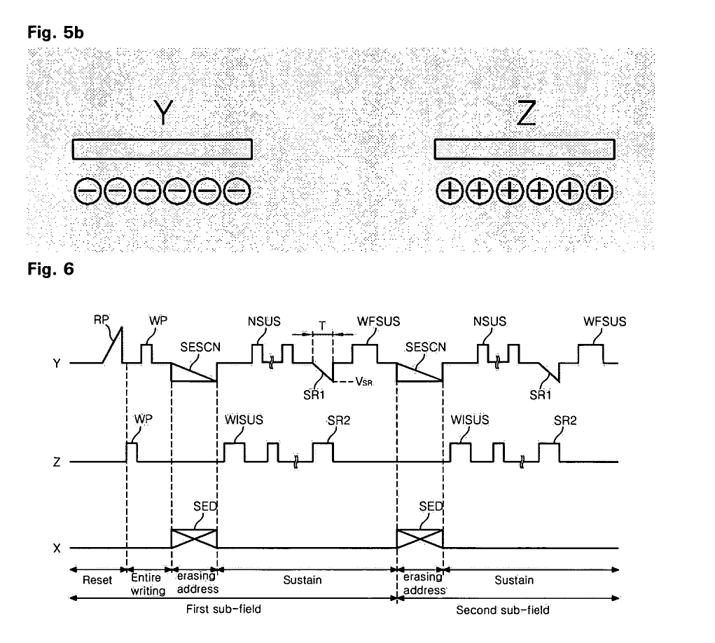

FIG. 6 shows a driving waveform supplied in the period of a selective erasing sub-field, for explaining a method of driving a PDP according to a first embodiment of the present invention.

Referring to FIG. 6, a first sub-field of a selective erasing mode includes a reset period, the entire writing period, an erase address period and a sustain period, and the remaining sub-fields of the selective erasing mode include only an erase address period and a sustain period.

That is, in a first sub-field of one frame, the entire write discharge is generated in the entire discharge cells. While unnecessary discharge cells are sequentially turned off in the remaining sub-fields, an image corresponding to data is displayed.

In the reset period and the entire writing period of the first sub-field, pulses of various shapes are applied. For explanation's convenience, the operation of the reset period and the entire writing period will be described using a ramp pulse RP and the entire writing pulse WP both of which are commonly used will be described.

During the reset period of the first sub-field, the ramp pulse RP is applied to the scan electrode lines Y. If the ramp pulse RP is applied to the scan electrode lines Y, a ramp discharge is generated in all of discharge cells and predetermined wall charges are formed by the ramp discharge. In this time, wall charges of the negative (−) polarity are formed in the scan electrode lines Y, and wall charges of the positive (+) polarity are formed in the sustain electrode lines Z.

During the entire writing period of the first sub-field, the entire writing pulse WP is applied to the sustain electrode lines Z and the scan electrode lines Y. In this time, the entire writing pulse WP is first applied to the sustain electrode lines Z so that it is overlapped with a voltage value of the wall charges formed in the reset period. As such, if the entire writing pulse WP is applied to the sustain electrode lines Z and the scan electrode lines Y, sufficient wall charges necessary for a sustain discharge are formed in the discharge cells.

Thereafter, in the erase address period, an erase data pulse SED is applied to the address electrode lines X and an erase scan pulse SESCN is also applied to the scan electrode lines Y. Thus, an erase address discharge is generated in the discharge cells to which the erase data pulse SED and the erase scan pulse SESCN are applied at the same time, whereby the wall charges formed during the entire writing period are erased.

At the start point of the sustain period, a start sustain pulse WISUS is applied to the sustain electrode lines Z. In this time, the start sustain pulse WISUS has a pulse width wider than that of a normal sustain pulse NSUS thereby generating a strong sustain discharge. Accordingly, the amount of wall charges within on-cells, i.e., discharge cells where the erase address discharge is not generated is further increased, thus stabilizing the sustain discharge.

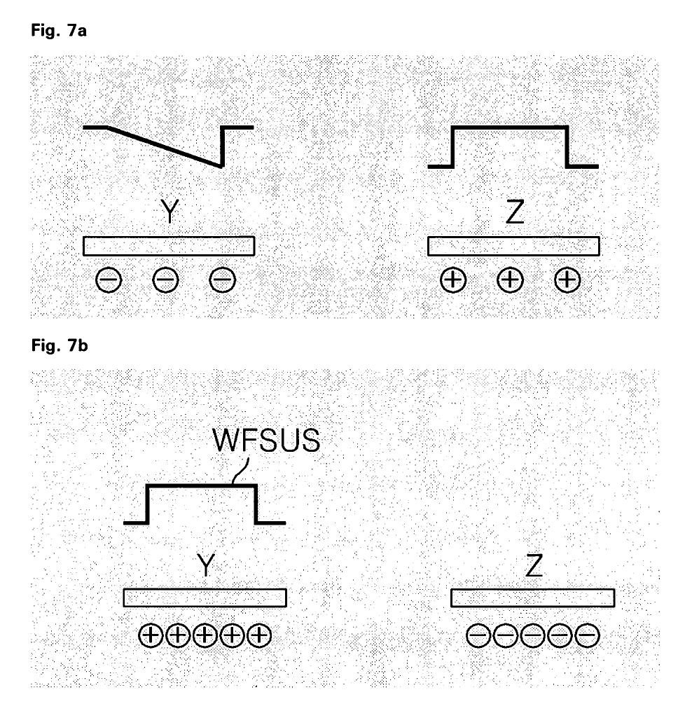

After the start sustain pulse WISUS is applied, the normal sustain pulses NSUS is alternately supplied to the sustain electrode lines Z and the scan electrode lines Y. This normal sustain pulses NSUS generates the sustain discharge in the on-cells. In this time, since the last normal sustain pulse NSUS is applied to the scan electrode lines Y, wall charges are formed in the discharge cells, as shown in FIG. 7a. In other words, wall charges of the negative (−) polarity are formed in the scan electrode lines Y and wall charges of the positive (+) polarity are formed in the sustain electrode lines Z.

Thereafter, a first wall charge enhanced pulse SR1 is applied to the scan electrode lines Y. A second wall charge enhanced pulse SR2 is also applied to the sustain electrode lines Z so that it is synchronized with the first wall charge enhanced pulse SR1. In this time, the first wall charge enhanced pulse SR1 is applied as a ramp pulse and the second wall charge enhanced pulse SR2 is applied as a square wave. Further, the second wall charge enhanced pulse SR2 may not be applied.

If the first wall charge enhanced pulse SR1 and the second wall charge enhanced pulse SR2 are applied, the wall charges formed in the on-cells and the voltage value are added to generate an enhanced discharge. In this time, since the first wall charge enhanced pulse SR1 and the second wall charge enhanced pulse SR2 are applied at the same time, a high voltage difference is generated between the scan electrode lines Y and the sustain electrode lines Z, so that a strong enhanced discharge happens. In addition, since the first wall charge enhanced pulse SR1 is applied as the ramp pulse, a large amount of the wall charges as shown in FIG. 7b is formed in the on-cells by the enhanced discharge. In the present invention, a voltage of the first wall charge enhanced pulse SR1 is set between −80V and −60V, preferably between −72V and −68V so that a large amount of wall charges is sufficiently formed in the on-cells. Also, a voltage value of the second wall charge enhanced pulse SR2 is set to be identical to that of the sustain pulses NSUS. Moreover, in the present invention, the application time of the first and second wall charge enhanced pulses SR1, SR2 is set to be within a range between 2 μs and 3 μs. It was experimentally found that if the application time of the first and second wall charge enhanced pulses SR1, SR2 is set to be higher than 3 μs, too many wall charges are formed thereby generating a self-erasing discharge and if the application time is set to be less than 2 μs, sufficient wall charges cannot be formed.

Thereafter, a last sustain pulse WFSUS having a wide pulse width is applied to the scan electrode lines Y. If the last sustain pulse WFSUS having this wide pulse width is applied, a strong sustain discharge is generated and many wall charges are thus formed. More particularly, the last sustain pulse WFSUS is overlapped with the voltage of the large amount of the wall charges formed by the first and second enhanced pulses SR1, SR2. As a result, sufficient wall charges as shown in FIG. 7c, which are necessary for an erase address period of a next sub-field, can be formed.

Next, during the period of the remaining sub-fields except for the first sub-field, an image corresponding to data is displayed while the erase address period and the sustain period are repeated. In this time, the first wall charge enhanced pulse SR1 and the second wall charge enhanced pulse SR2 can be applied to the sustain period of the entire sub-fields. In other words, sufficient wall charges can be formed so that the first and second wall charge enhanced pulses SR1, SR2 are applied to the sustain period of all the sub-fields and a stabilized erase discharge is thus generated in an erase address period of a next sub-field. Also, the first and second wall charge enhanced pulses SR1, SR2 can be applied to the sustain period of the remaining sub-fields except for the last sub-field. Practically, since a first sub-field of a next frame is located after the last sub-field, the first and second wall charge enhanced pulses SR1, SR2 cannot be applied.

Meanwhile, the first and second wall charge enhanced pulses SR1, SR2 can be applied only when the panel is driven at low temperature, i.e., at a temperature ranging from −50° C. to 0° C. In other words, when the panel is driven at a temperature higher than the low temperature, the first and second wall charge enhanced pulses SR1, SR2 may not be applied, but only when the panel is driven at low temperature, the first and second wall charge enhanced pulses SR1, SR2 can be applied. As such, if the first and second wall charge enhanced pulses SR1, SR2 are applied in a low temperature environment, the panel can be driven at low temperature in a stable manner.

### Second Embodiment

According to a second embodiment of the present invention, there is provided a method of driving a plasma display panel in which one frame includes a plurality of selective writing sub-fields and a plurality of selective erasing sub-fields, including the steps of alternately applying a first sustain pulse to the scan electrode lines and the sustain electrode lines during a sustain period of one or more selective writing sub-fields and one or more selective erasing sub-fields, applying a second sustain pulse having a pulse width wider than that of a first sustain pulse as a last sustain pulse in the sustain period, and before the second sustain pulse is applied, applying a wall charge enhanced pulse to one of the scan electrode lines and the sustain electrode lines.

The method further includes the step of, when the wall charge enhanced pulse is applied, applying a synchronization pulse to the other of the scan electrode lines and the sustain electrode lines to which the wall charge enhanced pulse is not applied so that the synchronization pulse is synchronized with the wall charge enhanced pulse.

The synchronization pulse is a square wave.

The synchronization pulse is set to have the same voltage value as the first sustain pulse.

The wall charge enhanced pulse has a voltage of negative polarity.

The wall charge enhanced pulse is a ramp wave that falls with a tilt.

The wall charge enhanced pulse falls to a voltage ranging from −80V to −60V.

The wall charge enhanced pulse falls to a voltage ranging from −72V to −68V.

The application time of the wall charge enhanced pulse is set to be within a range between 2 μs and 3 μs.

The wall charge enhanced pulse is applied in the sustain period of the selective erasing sub-fields and the sustain period of the last selective writing sub-field located before the selective erasing sub-field.

The wall charge enhanced pulse is applied in the sustain period of the remaining selective erasing sub-fields except for the last selective erasing sub-field and the sustain period of the last selective writing sub-field located before the selective erasing sub-field.

The wall charge enhanced pulse is applied only when the panel is driven in a low temperature environment.

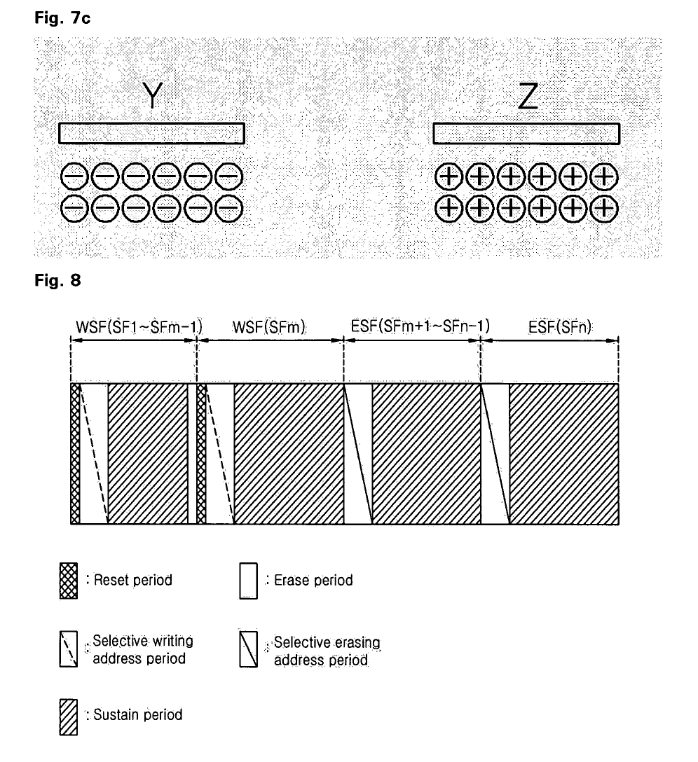

FIG. 8 shows a state where selective erasing sub-fields and selective writing sub-fields are positioned within one frame when the PDP of the present invention is driven.

Referring to FIG. 8, one frame of a SWSE mode includes a selective writing sub-field WSF having one or more sub-fields, and a selective erasing sub-field ESF having one or more sub-fields.

The selective writing sub-field WSF includes a m plurality (where, m is a positive integer greater than 0) of sub-fields SF1 to SFm. Each of the first to (m−1)^{th} sub-fields SF1 to SFm−1 except for the m^{th} sub-field SFm is driven with it being divided into a reset period for uniformly forming a given amount of wall charges in cells of the entire screen, a writing address period for selecting on-cells using a write discharge, a sustain period for generating a sustain discharge in the selected on-cells, and an erase period for erasing wall charges within cells after the sustain discharge.

The m^{th} sub-field SFm being the last sub-field of the selective writing sub-field WSF is divided into a reset period, a writing address period and a sustain period. The reset period, the write address period and the erase period of the selective writing sub-field WSF are set to have the same brightness weight every sub-fields SF1 to SFm, but the sustain period thereof is set to have identical or different brightness weight.

The selective erasing sub-field ESF includes a n-m (wherein, n is a positive integer greater than m) of sub-fields SFm+1 to SFn. Each of the (m+1)^{th} to n^{th} sub-fields SFm+1 to SFn is divided into an erase address period for selecting off-cells using an erase discharge and a sustain period for generating a sustain discharge in on-cells. In the sub-fields SFm+1 to SFn of the selective erasing sub-field ESF, the erase address period is set to be identical, and the sustain period is set to be identical or different depending on a relative brightness ratio.

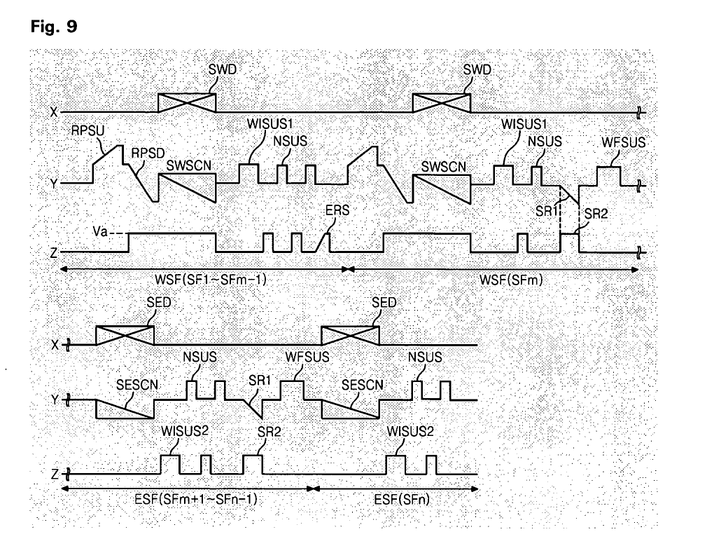

FIG. 9 shows a driving waveform supplied in the periods of a selective erasing sub-field and a selective writing sub-field, for explaining a method of driving a PDP according to a second embodiment of the present invention.

Referring to FIG. 9, in a reset period of the selective writing sub-field WSF, a ramp-up pulse RPSU and a ramp-down pulse RPSD are applied to the entire scan electrode lines Y. If the ramp-up pulse RPSU is applied to the scan electrode lines Y, a set-up discharge is generated thereby forming uniform wall charges in the discharge cells. Further, if the ramp-down pulse RPSD is applied to the scan electrode lines Y, a set-down discharge is generated thereby erasing some of wall charges formed redundantly. Meanwhile, when the ramp-down pulse RPSD is applied to the scan electrode lines Y, a DC voltage (Va) of the positive polarity is applied to the sustain electrode lines Z.

In a write address period, simultaneously when a write scan pulse SWSCN of negative polarity is sequentially applied to the scan electrode lines Y, a write data pulse SWD is applied to the address electrode lines X so that it is synchronized with the write scan pulse SWSCN. Then, as a voltage of the write scan pulse SWSCN and the write data pulse SWD and a wall voltage within the cell, which is accumulated previously, are added, a write discharge is generated in the cells to which the write data pulse SWD is applied and on-cells are thus selected. Further, wall charges of the positive polarity are accumulated on the scan electrode line Y and wall charges of negative polarity are accumulated on the sustain electrode line Z and the address electrode line X, by means of the write discharge. The wall charges formed thus serve to lower a voltage applied externally for generating a sustain discharge during the sustain period, i.e., a sustain voltage.

At the initial stage of the sustain period, a start sustain pulse WISUS1 is applied to the scan electrode lines Y. The start sustain pulse WISUS1 has a pulse width wider than that of a normal sustain pulse NSUS. Thus, this increases the amount of wall charges within on-cells than those when the normal sustain pulse NSUS is first applied to the sustain period, thereby stabilizing the sustain discharge. After the start sustain pulse WISUS1 is applied, the normal sustain pulse NSUS is alternately applied to the sustain electrode lines Z and the scan electrode lines Y. Further, since an erase pulse ERS is supplied in the first to (m−1)^{th} sub-fields SF1 to SFm−1 except for the m^{th} sub-field SFm being a preceding sub-field of the selective erasing sub-field ESF, the on-cells are turned off.

Meanwhile, the last sustain pulse WFSUS of the m^{th} sub-field SFm being the last sub-field of the selective writing sub-field WSF forms wall charges necessary for the period of a subsequent selective erasing sub-field whose pulse width is set to be wider than that of the normal sustain pulse NSUS. In this time, before the last sustain pulse WFSUS is applied, a first wall charge enhanced pulse SR1 is applied to the scan electrode lines Y, and a second wall charge enhanced pulse SR2 is applied to the sustain electrode lines Z so that it is synchronized with the first wall charge enhanced pulse SR1. In this time, the first wall charge enhanced pulse SR1 is applied as a ramp pulse and the second wall charge enhanced pulse SR2 is applied as a square wave.

If the first wall charge enhanced pulse SR1 and the second wall charge enhanced pulse SR2 are applied, the wall charges formed in the on-cells and the voltage value are added to generate an enhanced discharge. In this time, since the first wall charge enhanced pulse SR1 and the second wall charge enhanced pulse SR2 are applied at the same time, a high voltage difference is generated between the scan electrode lines Y and the sustain electrode lines Z, so that a strong enhanced discharge happens. In addition, since the first wall charge enhanced pulse SR1 is applied as the ramp pulse, a large amount of the wall charges as shown in FIG. 7b is formed in the on-cells by the enhanced discharge. In the present invention, a voltage of the first wall charge enhanced pulse SR1 is set between −80V and −60V, preferably between −72V and −68V so that a large amount of wall charges is sufficiently formed in the on-cells. Also, a voltage value of the second wall charge enhanced pulse SR2 is set to be identical to that of the sustain pulses NSUS. Moreover, in the present invention, the application time of the first and second wall charge enhanced pulses SR1, SR2 is set to be within a range between 2 μs and 3 μs.

If the first and second wall charge enhanced pulses SR1, SR2 are applied before the last sustain pulse WFSUS is applied, a strong sustain discharge is generated by the last sustain pulse WFSUS. Accordingly, sufficient wall charges necessary for an erase address period of a next sub-field can be formed, as shown in FIG. 7c.

Thereafter, in an address period of a subsequent selective erasing sub-field ESF, an erase scan pulse SESCN is sequentially applied to the scan electrode lines Y, and an erase data pulse SED which is synchronized with the erase scan pulse SESCN is also applied to the address electrode lines X. Then, as voltage value of the sufficient wall charges formed in previous on-cells and a voltage value of the erase scan pulse SESCN and the erase data pulse SED are added, an erase discharge is generated within the on-cells to which the erase data pulse SED is applied. Accordingly, the wall charges within the on-cells are erased by the erase discharge to the degree that does not generate a discharge although the sustain voltage is applied.

In a subsequent sustain period, a start sustain pulse WISUS2 having a wide pulse width is applied to the sustain electrode lines Z so that a sustain discharge can be generated stably. The normal sustain pulse NSUS is then alternately applied to the scan electrode lines Y and the sustain electrode lines Z whereby a sustain discharge is generated within the on-cells. Thereafter, a last sustain pulse WFSUS is applied to the scan electrode lines Y, thus forming wall charges necessary for a subsequent erase address period. In this time, before the last sustain pulse WFSUS is applied, the first and second wall charge enhanced pulses SR1, SR2 are applied to the scan electrode lines Y and the sustain electrode lines Z, respectively, so that a plurality of wall charges are formed in the on-cells. Therefore, sufficient wall charges necessary for a next erase address period can be formed by the last sustain pulse WFSUS.

Meanwhile, according to the present invention, the first and second wall charge enhanced pulses SR1, SR2 are applied in the sustain period of the last selective writing sub-field SFm and the sustain period of all the selective erasing sub-fields ESF. In this time, in the sustain period of the last selective erasing sub-field SFn, the first and second wall charge enhanced pulses SR1, SR2 may not be applied. In other words, after the sustain period of the last selective erasing sub-field SFn, the first sub-field SF1 of a next frame is located. It is thus not necessary to enhance wall charges by applying the first and second wall charge enhanced pulses SR1, SR2. Practically, whether the first and second wall charge enhanced pulses SR1, SR2 will be applied in the sustain period of the last selective erasing sub-field SFn can be decided depending on a designer.

Furthermore, according to the present invention, the first and second wall charge enhanced pulses SR1, SR2 can be applied only when a panel is driven at low temperature ranging from −50° C. to 0° C. In other words, when the panel is driven at a temperature higher than the low temperature, the first and second wall charge enhanced pulses SR1, SR2 are not applied. Only when the panel is driven at low temperature, the first and second wall charge enhanced pulses SR1, SR2 can be applied. As such, if the first and second wall charge enhanced pulses SR1, SR2 are applied in a low temperature environment, the panel can be driven stably at low temperature.

As described above, according to the present invention, a strong sustain discharge is generated by the last sustain pulse. Therefore, sufficient wall charges necessary for a next erase address period can be formed and an erroneous discharge can be thus prevented.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of driving a plasma display panel driven in a selective erasing mode, comprising the steps of:
alternately applying a first sustain pulse to scan electrode lines and sustain electrode lines in a sustain period;
applying a second sustain pulse having a pulse width wider than that of a first sustain pulse as a last sustain pulse in the sustain period; and
before the second sustain pulse is applied, applying a wall charge enhanced pulse to one of the scan electrode lines and the sustain electrode lines.

2. The method as claimed in claim 1, further comprising the step of, when the wall charge enhanced pulse is applied, applying a synchronization pulse to the other of the scan electrode lines and the sustain electrode lines to which the wall charge enhanced pulse is not applied so that the synchronization pulse is synchronized with the wall charge enhanced pulse.

3. The method as claimed in claim 2, wherein the synchronization pulse is a square wave.

4. The method as claimed in claim 2, wherein the synchronization pulse is set to have the same voltage value as the first sustain pulse.

5. The method as claimed in claim 1, wherein the wall charge enhanced pulse has a voltage of negative polarity.

6. The method as claimed in claim 1, wherein the wall charge enhanced pulse is a ramp wave that falls with a tilt.

7. The method as claimed in claim 5, wherein the wall charge enhanced pulse falls to a voltage ranging from −80V to −60V.

8. The method as claimed in claim 7, wherein the wall charge enhanced pulse falls to a voltage ranging from −72V to −68V.

9. The method as claimed in claim 1, wherein the application time of the wall charge enhanced pulse is set to be within a range between 2 μs and 3 μs.

10. The method as claimed in claim 1, wherein the wall charge enhanced pulse is applied in the sustain period of all the sub-fields included in one frame.

11. The method as claimed in claim 1, wherein the wall charge enhanced pulse is applied in the sustain period of the remaining sub-fields except for the last one among a plurality of sub-fields included in one frame.

12. The method as claimed in claim 1, wherein the wall charge enhanced pulse is applied only when the panel is driven in a low temperature environment.

13. A method of driving a plasma display panel in which one frame includes a plurality of selective writing sub-fields and a plurality of selective erasing sub-fields, comprising the steps of:
alternately applying a first sustain pulse to the scan electrode lines and the sustain electrode lines during a sustain period of one or more selective writing sub-fields and one or more selective erasing sub-fields;
applying a second sustain pulse having a pulse width wider than that of a first sustain pulse as a last sustain pulse in the sustain period; and
before the second sustain pulse is applied, applying a wall charge enhanced pulse to one of the scan electrode lines and the sustain electrode lines.

14. The method as claimed in claim 13, further comprising the step of, when the wall charge enhanced pulse is applied, applying a synchronization pulse to the other of the scan electrode lines and the sustain electrode lines to which the wall charge enhanced pulse is not applied so that the synchronization pulse is synchronized with the wall charge enhanced pulse.

15. The method as claimed in claim 14, wherein the synchronization pulse is a square wave.

16. The method as claimed in claim 14, wherein the synchronization pulse is set to have the same voltage value as the first sustain pulse.

17. The method as claimed in claim 13, wherein the wall charge enhanced pulse has a voltage of negative polarity.

18. The method as claimed in claim 13, wherein the wall charge enhanced pulse is a ramp wave that falls with a tilt.

19. The method as claimed in claim 17, wherein the wall charge enhanced pulse falls to a voltage ranging from −80V to −60V.

20. The method as claimed in claim 19, wherein the wall charge enhanced pulse falls to a voltage ranging from −72V to −68V.

21. The method as claimed in claim 13, wherein the application time of the wall charge enhanced pulse is set to be within a range between 2 μs and 3 μs.

22. The method as claimed in claim 13, wherein the wall charge enhanced pulse is applied in the sustain period of the selective erasing sub-fields and the sustain period of the last selective writing sub-field located before the selective erasing sub-field.

23. The method as claimed in claim 13, wherein the wall charge enhanced pulse is applied in the sustain period of the remaining selective erasing sub-fields except for the last selective erasing sub-field and the sustain period of the last selective writing sub-field located before the selective erasing sub-field.

24. The method as claimed in claim 13, wherein the wall charge enhanced pulse is applied only when the panel is driven in a low temperature environment.
